(19) United States
(12) Patent Application Publication
(10) Pub. No.: US 2014/0265563 A1
(43) Pub. Date: Sep. 18, 2014

(54) HIERARCHICAL POWER CONDITIONING AND DISTRIBUTION ARRAY

(71) Applicant: HENRY W. SCHRADER, MOUNTAIN VIEW, CA (US)

(72) Inventor: HENRY W. SCHRADER, MOUNTAIN VIEW, CA (US)

(21) Appl. No.: 13/833,801

(22) Filed: Mar. 15, 2013

(51) Int. Cl. H02J 1/00

(52) U.S. Cl. CPC H02J 1/00
USPC 307/18

(57) ABSTRACT

A system, method and apparatus for power bus distribution and maintenance.

### FIELD OF THE INVENTION

The invention relates to the field of equipment power distribution and management, such as power bus distribution and maintenance within equipment racks.

### BACKGROUND

Prior art rack systems typically utilize power zones in which each zone is associated with one or more respective power supplies. Unfortunately, if the power requirements of a particular zone exceed the capability of the power supplies allotted to that zone, then the power supplies of the particular zone must be replaced by larger power supplies or additional power supplies must be added to the zone. This is expensive and wasteful in terms of service calls, loss of investment in replaced power supplies, poor scalability and so on. This problem is exacerbated where equipment of varying power requirements may be used in a zone. In this case, the zone must include a power capability sufficient to handle the most demanding equipment contemplated for that zone.

### SUMMARY

Various deficiencies in the prior art are addressed by systems, methods and apparatus for power bus distribution and maintenance.

A system according to one embodiment comprises: a plurality of power sourcing devices connected in parallel for supplying power at a nominal voltage to a power bus of a printed circuit board (PCB); and a plurality of electromechanical interface devices connected in parallel to the power bus via the PCB; each power sourcing device comprising a plurality of DC/DC converters adapted to provide respective output power at said nominal voltage to an output terminal of the power sourcing device; and each power sourcing device comprising a controller for selectively enabling respective DC/DC converters to maintain the nominal voltage at the output terminal of the power sourcing device.

### BRIEF DESCRIPTION OF THE DRAWINGS

The teachings of the present invention can be readily understood by considering the following detailed description in conjunction with the accompanying drawings, in which:

FIG. 1 depicts a block diagram of a hierarchical power conditioning and distribution apparatus;

FIG. 2 depicts graphically depicts a rear view of a printed circuit board (PCB);

FIGS. 3-4 depict flow diagrams of power control and maintenance methods according to various embodiments; and

FIG. 5 depicts a high-level block diagram of a computer suitable for use in performing functions described herein.

To facilitate understanding, identical reference numerals have been used, where possible, to designate identical elements that are common to the figures.

### DETAILED DESCRIPTION

Various embodiments will be described within the context of a power distribution system adapted for use within an equipment rack, such as an equipment rack holding computer networking or telecommunications equipment. However, it will be appreciated by those skilled in the art that the various embodiments described herein are suitable for use within the context of any system in which a power bus is used by multiple power consuming devices.

FIG. 1 depicts a block diagram of a hierarchical power conditioning and distribution system. Specifically, the system 100 of FIG. 1 comprises a plurality of power equalizers (PEQs) 110-1, 110-2 and so on through 110-M (collectively PEQs 110), an optional power manager 120 and a plurality of electromechanical interface devices 130-1 through 130-X (collectively electromechanical interface devices 130).

Each of the power equalizers 110 is adapted to receive input power signal(s) via one or more battery feeds (or other power input means) and responsively produce an output power signal at some nominal DC voltage, illustratively 50 V, 5V, 12V, 24V, 40V or whatever voltage is appropriate for the application. The output power signal of each of the power equalizers 110 is connected in parallel to form thereby a power bus POWER BUS at the nominal DC voltage.

Each of the power equalizers 110 includes a plurality of DC/DC converters 112, the controller 114 and a power monitoring circuit (PMON) 116. For example, a first PEQ 110-1 is depicted as including a plurality of DC/DC converters 112-1 through 112-N (collectively DC/DC converters 112), a controller 114 power monitoring circuit (PMON) 116.

Each DC/DC converter 112 within a power equalizer 110 converts an input power signal, such as an input DC signal received from a battery feed or other source, to a respective output power signal at a nominal DC output voltage common to each of the DC/DC converters 112. The output power signals of the DC/DC converters 112 are connected in parallel to provide thereby a PEQ output signal at the nominal DC output voltage.

While the various battery feeds (or other power input means) may be at the same or different voltage levels, these voltage levels should be within an input voltage range compatible with that of the DC/DC converters 112 within the power equalizer 110, illustratively 36-75 V for a typical DC/DC converter having a nominal output voltage of 50 V.

The PMON 116 measures the PEQ output signal and communicates this measurement to the controller 114. The PMON 116 may operate according to any of a plurality of known techniques to measure the output voltage and/or other power characteristics to determine whether or not the PEQ output signal conforms to an appropriate voltage level or power profile.

Each PMON 116 in each of the various PEQs 110 operates in substantially the same manner, and uses a decision making mechanism common to all the PEQs, such as for determining whether a slot (i.e., power consuming device) should be powered down or up, which slot should be powered down or up, the conditions by which this decision should be made and so on.

The controller 114 communicates with the PMON 116, DC/DC converters 112 and other elements (not shown) within the power equalizer 110. In various embodiments, the controller 114 communicates with optional power controller 120 via a Power Manager Bus (PMB), with the other controllers 114 in other PEQs 110 via an Activity Bus (AB), and/or with various power consuming devices connected to the electromechanical interface devices 130 via a Slot Management Bus (SMB). The controller 114 performs various control functions that will be described in more detail below.

The Power Manager Bus (PMB), Activity Bus (AB) and Slot Management Bus (SMB) may be implemented via discrete or multiplexed connections, I2C bus, or any bus or protocol suitable for use in performing the stated functions. Moreover, each bus may be implemented using the same or different technologies.

The controller 114 may be implemented as a microprocessor-based or computer-based element such as generally described below with respect to FIG. 5, a programmable logical element and/or the special-purpose circuit. It is noted that while the controller 114 and PMON 116 are depicted as separate components within the power equalizer 110, these functions may be implemented within a single component, such as the controller 114. Moreover, while various power conditioning circuitry, electrical isolation circuitry and so on has been omitted for clarity, those skilled in the art will understand that appropriate circuitry will be included within an implemented system

In various embodiments where there is no power manager 120, the controllers 114 are preconfigured to perform the various functions as described herein. In various embodiments there is a power manager 120, the controllers 114 are preconfigured to perform the various functions as described herein and/or receive control signal from the power manager 120 adapted to initiate or modify the operation of the controllers 114 such as described herein.

The power manager 120 may comprise a standalone element as depicted in FIG. 1, and may be implemented as a microprocessor-based or computer-based element such as generally described below with respect to FIG. 5, a programmable logical element and/or the special-purpose circuit. Alternatively, the power manager 120 may comprise a virtual element in that it is implemented as a software or firmware function within a broader management or controller element. In one embodiment, the power manager 120 is implemented within a control card of a switching system, such as a router, service gateway (SGW), packet gateway (PGW) and the like.

The optional power manager 120 provides information via the PMB to the controllers 114 of the various power equalizers 110 to enable various functions as described in more detail below. Such information may comprise specific power consumption data, ratings or even a power consumption profile associated with a power consuming device. The power consumption profile may be used to indicate one or more of power rating, power requirements, expected power consumption over time, nominal operating power consumption, peak power consumption, amount of time before the power consuming device begins operation and other data useful in determining whether or not the power bus has appropriate capacity.

In various embodiments, the power manager 120 provides threshold information to the controllers 114 of the power equalizers 110 for use in determining the threshold level at which one or more DC/DC converter should be enabled or disabled. The threshold information may comprise a percentage under/over nominal (e.g., about 2%, about 5%, about 10%, about 20% etc. away from nominal), a specific minimum voltage (e.g., approximately 49V, 47V, 45V, 40V and the like) and so on. In various embodiments, this information is preconfigured for the controllers 114.

The power manager 120 optionally monitors the digital power bus POWER BUS, individual PEQ output levels and so on by reading the status of the individual equalizers via the PMB or other suitable means. Optionally, the power manager 120 determines if the monitored signals indicate that a change in power allocations is appropriate; namely, an increase or decrease in a number of enabled DC power equalizers 110.

Each of the electromechanical interface devices 130, illustratively, card edge connectors or “slots,” is adapted to electromechanically cooperate with a power consuming device, such as a switching module, control module, input-output (I/O) module or other power consuming device.

Each of the electromechanical interface devices 130 is depicted as including several electrical terminals; namely, positive (+) and negative (−) power bus terminals and a slot power enable (PE) terminal.

The positive (+) and negative (−) power bus terminals are used to deliver power from the power bus to the power consuming device. As will be appreciated by those skilled in the art, multiple terminals may be used for the same function (e.g., power bus connections) where current carrying capacity of the particular terminal is insufficient. Thus, more terminals may be used to couple a power consuming device to the power bus.

The PE terminal is used to deliver a slot power enable (PE) signal from the slot management bus (SMB) that is adapted to cause the power consuming device to shut down or power up (i.e., power disable or power enable). That is, the SMB provides a PE signal to the slot to inform the power consuming device (or power generating device) connected to the slot that it should energize (enable) or de-energize (disable) itself. The PE signals for the various electromechanical interface devices 130 are provided by the power equalizers 110. The PE signal provided via the SMB may comprise an I2C signal, a multiplexed slot signal, a discrete slot signal or any other type of control signal, bus, or indicator suitable for use in communicating to the power consuming devices via the electromechanical interface devices 130.

The various RMB, AB, SMB, power enable and/or communications signals may be implemented via any known signaling mechanism, such as direct connection, optically isolated switch, I2C interface or other signaling mechanism.

Power Equalizer Function

Generally speaking, the function of each power equalizer 110 is to take any of a broad range (e.g., 36-75 V) of redundant battery feeds, OR them together to thereby select the feed with the highest potential, and convert the selected feed to a power bus POWER BUS having a nominal voltage, illustratively 50 V. This sharing/conversion of battery feeds is performed by each of the plurality of DC/DC converters 112 within each power equalizer 110, and then again by each of the power equalizers 110. In this manner, power equalizers receiving a 36 V input signal may share their nominal 50 V output signal with the nominal 50 V output signal of power equalizers receiving a 75 volt input signal. That is, the power is “equalized” in terms of voltage output.

All of the output signals provided by the power equalizers 110 are shared/combined into a common power bus. The total power associated with the common power bus is determined by the number of power equalizers 110 supplying power to the bus and, more particularly, the number of DC/DC converters 112 within the various power equalizers 110.

Unlike centralized power control methodologies, the various embodiments achieve rapid load regulation and as well as rapid response to failure conditions by including intelligent management functionality within each of the power equalizers 110, such as within the exemplary system 100 of FIG. 1. This intelligent management functionality is primarily implemented using the controller 114 included within each of the power equalizers 110, as will now be described in more detail.

First Control Loop

In a first mode of operation, the controller 114 selectively enables or disables the various DC/DC converters 112 in the power equalizer 110 in response to measurements of the PEQ output signal provided by the PMON 116. This mode of operation implements a first type of control loop adapted to provide a very fast load regulation capability to the power equalizer 110.

For example, if the voltage of the PEQ output signal drops below a threshold level from the nominal voltage level (e.g., about 2%, 5%, 10% or some other threshold amount), then the controller 114 enables or energizes one or more off-line DC/DC converters 112 within the power equalizer 110 to address a potential brownout or overload condition. Optionally, if the voltage of the PEQ output signal increases above a threshold level from the nominal voltage level (e.g., about 2%, 5%, 10% or some other threshold amount), then the controller 114 disables or de-energizes one or more online DC/DC converters within the power equalizer 110 to address a potential high-voltage or under load condition (or simply conserve energy).

Thus, within a power equalizer 110 the controller 114 and PMON 116 form a first type of control loop adapted to selectively enable DC/DC converters 112 to ensure that the nominal output voltage of the PEQ output signal is maintained at the desired level. This first type of control loop enables the power equalizer 110 to independently and rapidly react to changes in its respective PEQ output signal to provide thereby an extremely fast response to load variations indicative of an actual or pending brownout condition for one or more power consuming devices.

In various embodiments, this first type of control loop is implemented within each of the power equalizers 110 such as where the power equalizers 110 in a system 100 are implemented in a substantially similar manner to simplify maintenance and replacement inventory requirements.

In various embodiments, a first portion of the power equalizers 110 within a system 100 do not include the first type of control loop, while a remaining portion of the power equalizers 110 do include the first type of control loop. In these embodiments, the first portion of power equalizers 110 may be used to provide a minimum or baseline amount of power while the remaining portion provides a variable amount of power and is adapted to provide the bulk of load regulation to the power bus.

Second Control Loop

In a second mode of operation, the controller 114 selectively enables or disables power consuming devices connected to one or more of the electromechanical interface devices. This mode of operation implements a second type of control loop adapted to selectively reduce power bus demand in certain situations, such as when insufficient capacity exists due to a failed power equalizer 110 or portion thereof.

Specifically, each active power equalizer 110 communicates with the other active power equalizers 110 via the activity bus AB. Thus, each PEQ 110 is aware of the number of active PEQs 110. Each PEQ 110 includes a common table (or other common determining mechanism) that identifies how many slots 130 may be powered for each number of active PEQs 110. If too few PEQs are active, then some of the slots 130 are disabled by PE signals sent via the SMB.

For example, if the voltage of the PEQ output signal drops or remains below a threshold level from the nominal voltage level even after all of the DC/DC converters are energized (e.g., such as during the first mode of operation), then it is likely the case that the total capacity of the on-line power equalizers 110 is insufficient to meet the power bus demand of the enabled power consuming devices plugged into or otherwise connected to the electromechanical interface devices 130. In this case, one or more of these power consuming devices are disabled to avoid a brownout or blackout condition for the other power consuming devices.

Thus, within a power equalizer 110 the controller 114 and PMON 116 also form a second type of loop adapted to selectively enable/disable power consuming equipment to ensure that the nominal voltage of the power bus is maintained at the desired level. This second type of control loop enables the power equalizer 110 to independently and rapidly react to changes in power bus demands due to power consuming equipment addition, deletion, failure and/or other conditions in a controlled manner.

Generally speaking, each controller 114 utilizes a common mechanism to determine which power consuming device should be enabled or disabled. In this manner, a determination by any of the controllers 114 of the power equalizers 110 will be the same as that of any other controller 114. In various embodiments, multiple mechanisms may be used to make this determination.

In various embodiments, certain PEQs 110 are associated with certain slots 130. In various embodiments, there is a priority order associated with the slots 130, wherein certain slots are given priority over other slots in term of power enable/disable order or sequence.

In various embodiments, all of the controllers 114 are capable of performing the PE function with respect to the power consuming devices. In various other embodiments, only some (one or more but not all) of the controllers 114 are capable of performing the PE function with respect to the power consuming devices.

Thus, various mechanisms are implemented by storing in memory associated with the controllers 114 information pertaining to whether or not a particular power consuming device should be enabled or disabled. The information may comprise a priority sequence or order in which power consuming devices should be disabled, with lower priority devices being disabled first in an attempt to keep the power bus at the nominal voltage.

In various embodiments, the information comprises a table of data indicative of the number of active power equalizers 110 and the number of active power consuming devices or (power) enabled slots. For example, if three power equalizers 110 are able to support a power bus connected to six power consuming devices, then data indicative of the removal of two power consuming devices (e.g., from the power controller 120) will be interpreted as an ability to shut down or disable one power equalizer 110. The information will define the specific power equalizer to be shut down (e.g., an order of priority among the PEQs 110).

Thus, each of the active PEQs may use a common mechanism to individually determine (in the same manner) how many active PEQs exist (i.e., are online), and which slots are able to be powered thereby.

Third Control Loop

In a third mode of operation, the controller 114 selectively enables or disables all (or most) of the DC/DC converters 112 in the power equalizer 110 in response to a power enable (PE) signal provided by the power manager 120 via the Power Manager Bus (PMB). This mode of operation may be part of a third type of control loop wherein the power manager 120 selectively enables or disables entire power equalizers 110 in response to an expected load requirement or other.

For example, if the power manager 120 receives information from some other management entity that a particular power consuming device is experiencing a fault condition, then this information may be communicated to the power equalizers 110 such that they can shut down the power consuming device via the PE signal at the appropriate connector 130. Similarly, if the power manager 120 receives information from some other management entity that a particular power consuming device is to be connected, then the power manager 120 may selectively enable additional power equalizers 120 or provide information to the power equalizers 110 such that the controllers 114 may energize additional DC/DC converters 112.

Thus, the power controller 120 forms a third type of loop adapted to selectively enable/disable power equalizers in response to conditions determined at a management level, such actual or expected changes in power bus demands due to power consuming equipment addition, deletion, failure and/or other conditions in a controlled manner.

FIG. 2 graphically depicts a rear view of a printed circuit board (PCB) adapted to distribute power within an equipment rack. Specifically, the PCB 200 includes a plurality of input terminal pairs 205 (illustratively 24) adapted to receive input power signals such as from battery or other power sources, and a plurality of power equalizer slots 210 (illustratively 12) to electrically and mechanically cooperates with a plurality of power equalizers.

As previously noted with respect to FIG. 1, the input power signals are connected to the power equalizers 110 to energize the DC/DC converters 112. As such, the PCB 200 includes a plurality of conductive paths (not shown) between the input terminal pairs 205 and the power equalizer slots 210 to implement this connectivity.

As previously noted with respect to FIG. 1, the output signals of the various power equalizers 110 are connected in parallel to form thereby a power bus POWER BUS, illustratively a 50 V bus. As such, the PCB 200 includes a plurality of conductive paths (not shown) between the power equalizer slots 210 and the power bus built into the PCB 200 to implement this connectivity. The power bus may comprise multiple conductive paths distributed across multiple layers of the PCB 200.

In various embodiments, the PCB 200 is used as a backplane within the context of an equipment rack. That is, the PCB 200 is adapted to receive input power via the terminal 205, cooperate with power equalizers 110 via corresponding slots 210, and provide the power bus to support power consuming devices.

The PCB 200 is also depicted as including an output terminal pair adapted to operate as the power bus. However, in various embodiments where a single PCB is used as a backplane for an entire equipment rack, there is no need for power bus output terminals since the power bus is implemented using PCB conductive paths. That is, some embodiments contemplate an equipment rack wherein a large PCB is used as a backplane for power sourcing devices such as the power equalizers 110 as well as power consuming devices. In these embodiments, the power bus is used to supply power to power to devices via conductive paths on one or more layers of the PCB 200. Various other embodiments contemplate equipment racks wherein one PCB is used as a backplane for power sourcing devices, while one or more other PCBs are used as backplane for power consuming devices. In these embodiments, the power bus is connected between the various PCBs via wiring between the terminals or other means.

In various embodiments, the form factor of the power equalizers 110 fits within the height of a single rack unit (i.e., one RU). As such, multiple power equalizers 110 may be arranged on a single rack unit tray or shelf which then slides into the equipment rack such that the inventor mechanical connections of the power equalizers 110 (e.g., card edges) engage the corresponding power equalizer electromechanical connections (e.g., slots) of the PCB 200. Thus, as depicted in FIG. 2, each of three shelves supports a respective four power equalizers.

Thus, FIGS. 1-2 depicts a hierarchical power conditioning and distribution array is based upon an array of arrays; namely, a first array of devices (power equalizers 110) adapted to supply power at a common nominal voltage to a common power bus, where each of the devices comprises a respective second array of devices (DC/DC converters 112) adapted to convert the output from any of a plurality of power sources to a common nominal voltage level. The insertion or removal of a power equalizer 110 from the PCB backplane 200 does not change the voltage of the power bus, though the total power capacity of that bus will change accordingly.

In various embodiments, each of the power equalizers within the system is hot swappable. Similarly, each of the DC/DC converters within a power equalizer is also hot swappable (though, as a practical matter, the power equalizer will likely need to be removed from the system to reach a malfunctioning DC/DC converter).

As noted above with respect to FIG. 2, power distribution is accomplished via a PC board (PCB) backplane adapted to physically receive the power equalizers 110 and electrically share/combine the power equalizers 110 output signal, which is communicated to power consuming devices as a power bus POWER BUS, illustratively a 50 V power bus.

The common power bus provides power to each of the slots in the chassis, such as slots for receiving line cards or other types of cards.

To control power consumption (i.e., to enable a line card or other backplane slot device to extract power from the power bus), optoelectronic power enabling circuitry is used. Other mechanisms may also be used to control whether or not the device within the backplane slot is able to receive power.

In various embodiments, to ensure that the power bus is adequate with respect to the total number of cards inserted within the various PCB slots, each of the cards adapted for use in the PCB slots includes circuitry for controlling power consumption (i.e., on/off circuitry or power down circuitry). Various embodiments utilize low voltage/low-power “power enabled” signaling, such as signals sufficient for driving simple optoelectronic switching circuits on the slotted power equalizer cards. Other mechanisms may also be used to control whether or not a card or device is a mechanically communicating with a backplane slot is enabled to receive power.

Thus, the PCB backplane provides paths for the power bus as well as a path for carrying “power enable” signals to each of the slots, such as the SMB.

In various embodiments, each of the slots communicating with the PCB backplane (i.e., each of the cards inserted in the slots) is associated with a bit within an array of bits representing the various slots within the system chassis. When the bit associated with a slot is in a first state (e.g., a “1”), then the respective “power enabled” signal is adapted to cause the card within that slot to begin drawing power from the power bus. Similarly, when the bit associated with a slot is in a second state (e.g., a “0”), then the respective “power enabled” signal is adapted to cause the card within that slot to stop drawing power from the power bus.

The array of bits described above forms a virtual banking mechanism for selecting which of the loads (i.e., slotted cards) will be enabled for power consumption. Advantageously, the virtual banking mechanism enables precise control of the power consumption in the racked system so that the existing capacity of the power conversion circuitry is not exceeded.

Advantageously, by utilizing a hierarchical power conditioning and distribution array, additional power conversion circuitry may be added to the existing power conversion circuitry to increase total power capacity without negating the acquisition cost associated with the existing power conversion circuitry. In other words, power conversion capacity scales well and prior investments in our prayers circuitry are retained as system power demand increase.

FIG. 3 depicts a flow diagram of a power control and maintenance method according to one embodiment. Specifically, FIG. 3 depicts a method 300 suitable for use by a controller 114 within a power equalizer 110 such as described herein with respect to the various figures.

At step 310, the controller 114 receives power monitor signals, power monitoring data and/or other information relevant to the various functions described herein.

At step 320, a determination is made as to whether any of the received signals or data indicate that a failure or warning condition exists. Referring to box 325, such failure or warning conditions may be associated with a low voltage of the power equalizer 110, a low voltage or power level of the power bus, a broken power bus, the addition or removal of a DC/DC converter, the addition or removal of a power equalizer, a DC/DC converter failure or warning condition, a power equalizer failure or warning condition as well as other conditions and events.

At step 330, the power manager 120 adapts its operation to any failure or warning condition determined at step 320. Referring to box 335, such adaptation may comprise enabling additional DC/DC converters (e.g., to address a low power bus condition, prepare for new power consuming devices and the like), disabling some DC/DC converters (e.g., to avoid wasting energy where power consuming devices have been disabled or removed, to take failed or failing devices off-line and the like), disabling one or more power consuming devices (e.g., such as where the device is malfunctioning or of lower priority than other power consuming devices in a constrained power situation), to generate fault messages (e.g., to alert network management system or repair/maintenance personnel) and/or take other actions.

FIG. 4 depicts a flow diagram of a power control and maintenance method according to one embodiment. Specifically, FIG. 4 depicts a method 400 suitable for use by a remote or local power controller 120 such as described herein with respect to the various figures.

At step 410, the power manager 120 receives any of power management signals, power monitor signals, power monitoring data and/or other information relevant to the power management function, such as described herein.

At step 420, a determination is made as to whether any of the received signals or data indicate that a failure or warning condition exists. Referring to box 425, such failure or warning conditions may be associated with a low voltage or power level of a bus, a broken power bus, the addition or removal of a power equalizer, a DC/DC converter failure or warning condition, a power equalizer failure or warning condition, the insertion of a power consuming card into a slot, the removal of a power consuming card from a slot, as well as other conditions and events.

At step 430, the power manager 120 adapts its operation to any failure or warning condition determined at step 420. Referring to box 435, such adaptation may comprise enabling one or more additional power equalizers (e.g., to address a low power bus condition, prepare for new power consuming devices and the like), disabling one or more power equalizers (e.g., to avoid wasting energy where power consuming devices have been disabled or removed, to take failed or failing devices off-line and the like), disabling one or more power consuming devices via a signal to the controllers 114 (e.g., such as where the device is malfunctioning or of lower priority than other power consuming devices in a constrained power situation), to generate fault messages (e.g., to alert network management system or repair/maintenance personnel), to generate a maintenance request and/or take other actions.

The power control and maintenance methods described above with respect to FIGS. 3-4 generally contemplate distinct operations of the various controllers 114 and power manager 120. However, in various embodiments functions described with respect to the method 300 of FIG. 3 may also or alternatively be implemented within the power manager 120. Similarly, in various embodiments functions described with respect to the method 400 of FIG. 4 may also or alternatively be implemented within one or more of the controllers 114. In various embodiments functions may be duplicated between the power manger 120 and controllers 114.

FIG. 5 depicts a high-level block diagram of a computer suitable for use in performing various functions and methodologies as described herein, including those described above with respect to the controller 114 and/or power manager 120.

As depicted in FIG. 5, computer 500 includes a processor element 503 (e.g., a central processing unit (CPU) and/or other suitable processor(s)), a memory 504 (e.g., random access memory (RAM), read only memory (ROM), and the like), a cooperating module/process 505, and various input/output devices 506 (e.g., a user input device (such as a keyboard, a keypad, a mouse, and the like), a user output device (such as a display, a speaker, and the like), an input port, an output port, a receiver, a transmitter, and storage devices (e.g., a persistent solid state drive, a hard disk drive, a compact disk drive, and the like)).

It will be appreciated that the functions depicted and described herein may be implemented in software and/or in a combination of software and hardware, e.g., using a general purpose computer, one or more application specific integrated circuits (ASIC), and/or any other hardware equivalents. In one embodiment, the cooperating process 505 can be loaded into memory 504 and executed by processor 503 to implement the functions as discussed herein. Thus, cooperating process 505 (including associated data structures) can be stored on a computer readable storage medium, e.g., RAM memory, magnetic or optical drive or diskette, and the like.

It will be appreciated that computer 500 depicted in FIG. 5 provides a general architecture and functionality suitable for implementing functional elements described herein or portions of the functional elements described herein.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in tangible and non-transitory computer readable medium such as fixed or removable media or memory, transmitted via a tangible or intangible data stream in a broadcast or other signal bearing medium, and/or stored within a memory within a computing device operating according to the instructions.

While the foregoing is directed to various embodiments of the present invention, other and further embodiments of the invention may be devised without departing from the basic scope thereof. As such, the appropriate scope of the invention is to be determined according to the claims.

What is claimed is:

1. A system, comprising:
a plurality of power sourcing devices connected in parallel for supplying power at a nominal voltage to a power bus of a printed circuit board (PCB); and
a plurality of electromechanical interface devices connected in parallel to said power bus via said PCB;
each power sourcing device comprising a plurality of DC/DC converters adapted to provide respective output power at said nominal voltage to an output terminal of the power sourcing device;
each power sourcing device comprising a controller for selectively enabling respective DC/DC converters to maintain said nominal voltage at said output terminal of the power sourcing device.

2. The system of claim 1, wherein said controller enables an offline DC/DC converter in response to said output terminal of the power sourcing device exhibiting a voltage below a threshold level.

3. The system of claim 2, wherein said threshold level comprises a level of about 2%, about 5% or about 10% away from said nominal voltage.

4. The system of claim 2, wherein said threshold level is defined in accordance with a control signal received from a power manager.

5. The system of claim 1, wherein:
each electromechanical interface device adapted to cooperate with a power consuming device and connect said power bus and a power enable (PE) signal thereto;
wherein said controller is adapted for selectively disabling said power consuming devices via said PE signal in response to said output terminal of the power sourcing device exhibiting a voltage below a threshold level when all respective DC/DC converters are enabled.

6. The system of claim 5, wherein said threshold level comprises a level of about 2%, about 5% or about 10% away from said nominal voltage.

7. The system of claim 5, wherein said threshold level is defined in accordance with a control signal received from a power controller.

8. The system of claim 5, wherein each controller in each power sourcing device includes a common mechanism for determining that a power consuming device should be disabled.

9. The system of claim 8, wherein each controller in each power sourcing device includes a common mechanism for determining a priority order for shutting down power consuming devices.

10. The system of claim 1, further comprising a power manager adapted to selectively disable said power sourcing devices via a control signal.

11. The system of claim 8, further comprising a power manager adapted to provide information for use by said common mechanism.

12. The system of claim 5, further comprising a power manager adapted to selectively disable said power consuming devices via a control signal sent to said controllers.

13. An apparatus, comprising:
a printed circuit board (PCB) adapted for use as a backplane for receiving and routing power between a plurality of power sourcing devices and a plurality of power consuming devices via a power bus;
each of said power sourcing devices having power output terminals connected to said power bus, each power sourcing device comprising a plurality of DC/DC converters adapted to provide an output signal of a common nominal voltage at the power output terminals of the power sourcing device; and
a controller, for selectively enabling one or more of said DC/DC converters in response to power bus requirements.

14. The apparatus of claim 13, further comprising:
a plurality of card edge connectors disposed upon the PCB and adapted to receive said power consuming devices, each of said card edge connectors having one or more terminals for connecting said power bus to a power consuming device.

15. A method of maintaining a nominal voltage at a power bus, comprising:
generating, at each of a plurality of power sourcing devices, a respective output power signal at said nominal voltage level, each of said power sourcing devices including one or more DC/DC converters adapted to provide a respective output power signal at said nominal voltage to a power sourcing device output terminal, each of said power sourcing devices selectively enabling respective DC/DC converters to maintain thereby said nominal voltage at a respective power sourcing device output terminal; and
combining said power sourcing device output signals to provide a combined power signal for said power bus.
